(19) United States
(12) Patent Application Publication
(10) Pub. No.: US 2007/0252824 A1
(43) Pub. Date: Nov. 1, 2007

(54) Image forming apparatus, setting input displaying method, program, and recording medium

(75) Inventors: Mikiya Okada, Nara (JP); Yoshimune Noda, Nara (JP); Kazuyuki Ogida, Kyoto (JP); Takao Fujita, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 11/786,868

(22) Filed: Apr. 12, 2007

(30) Foreign Application Priority Data
Apr. 28, 2006 (JP) 2006-125909

(51) Int. Cl. G06F 3/041

(52) U.S. Cl. 345/173

(57) ABSTRACT

The object is to provide an image forming apparatus that can easily input a setting value associated with a fractional number from a keypad. In a fractional number input mode, if a numeric value (i) is input from the numeric keypad, it is determined whether the numeric value is within an input range set as a numeric value of an integer portion; if a next input numeric value (ii) can be both the one's place of the integer portion and a numerator of a fractional portion, (i) and (ii) are not determined; if both portions can be determined by a next input numeric value (iii), the integer portion displays (i), the numerator portion displays (ii) and “/”; and if the numeric value (iii) can only be a denominator, (i), (ii), and (iii) are defined as the integer, the numerator, and the denominator, respectively.

This Non-provisional application claims priority under 35 U.S.C. §119 (a) on Patent Application No. 2006-125909 filed in JAPAN on Apr. 28, 2006, the entire contents of which are hereby incorporated herein by reference.

### FIELD OF THE INVENTION

The present invention relates to an image forming apparatus including an operating unit that can display a setting input screen setting an image forming condition, a setting input displaying method thereof, a program, and a recording medium.

### BACKGROUND OF THE INVENTION

Generally, an image forming apparatus such as a digital composite machine is disposed with an operating unit that integrates a setting input touch panel with a liquid crystal panel displaying various pieces of information such as a setting screen, and a numeric keypad for specifying the number of copies and inputting other types of numeric information, and if an image forming condition is set with a numeric value, the setting can generally be performed by using up/down keys displayed near a setting value displaying area corresponding to a setting item and repeating the touch operation until a desired numeric value is displayed. However, since the touch operation must be repeated many times, the input operation with the up/down keys requires time and effort and the operationality is poor.

To solve such a problem, for example, setting value input may be facilitated by registering setting values in advance as shown in Japanese Laid-Open Patent Publication No. 6-119096.

In the above conventional technology, since the setting value can be input not only with the up/down keys but also with a numeric keypad displayed on another screen, the problem of the up/down keys does not exist. However, the displayed numeric keypad is used for inputting normal numeric values, and numeric values of a unit system represented by fractional numbers are not considered to be input. Therefore, if a numeric value associated with a fractional number is input, the up/down keys are generally utilized. Although dedicated input keys may be disposed for fractional numbers in addition to the numeric keypad, it is difficult to employ the dedicated input keys because the space for disposing the operating unit is limited in devices such as the image forming apparatus and costs are increased. Although the setting input screen may display a numeric keypad that can input fractional numbers, if a numeric keypad is displayed on a display screen having a limited size, an area for displaying other pieces of information is reduced, and since information related to the setting input cannot sufficiently be displayed, it is disadvantageous that the setting operation is difficult to understand.

### SUMMARY OF THE INVENTION

The present invention was conceived in view of the above situations and it is therefore the object of the present invention to provide an image forming apparatus including an operating unit that can easily input a setting value associated with a fractional number from a normal numeric keypad, a setting input displaying method, a program, and a recording medium.

The first invention is an image forming apparatus comprising an operating unit including a displaying unit that can display a setting input screen setting an image forming condition, an input unit that includes a numeric keypad inputting numeric information, and an input display controlling unit that displays information input from the input unit on the displaying unit,

in a setting input mode that sets the image forming condition with a numeric value in a unit system using a fractional number display, the input display controlling unit displaying the numeric information input from the numeric keypad as a fractional number in a setting value display area of the setting input screen.

The second invention is the image forming apparatus of the first invention, wherein when numeric information corresponding to a numerator of a fractional number is input from the numeric keypad, the input display controlling unit displays the numeric information as a numeric value for a numerator along with a fraction symbol.

The third invention is the image forming apparatus of the second invention, wherein in the case of a denominator input waiting state that displays a numeric value for a numerator and a fraction symbol, the input display controlling unit displays a cursor at a position of a denominator.

The forth invention is the image forming apparatus of any one of the first to third invention, wherein the input display controlling unit determines whether the numeric information input from the numeric keypad is an available numeric value and invalidates the input of the numeric information in the case of an unavailable numeric value.

The fifth invention is the image forming apparatus of the forth invention, wherein the determination is performed based on a setting value input range that is preliminarily set for each of the image forming conditions and information about a denominator that specifies a fractional minimum unit in the unit system and about a denominator when a fractional number can be reduced.

The sixth invention is the image forming apparatus of any one of the first to third invention, wherein the unit system is an inch system and wherein the fractional minimum unit is ⅛ inch.

The seventh invention is the image forming apparatus of any one of the first to third invention, wherein when the setting mode is selected, the input display controlling unit displays a default value in the setting value display area of the setting input screen.

The eighth invention is the image forming apparatus of the seventh invention, wherein the input display controlling unit increases/decreases the numeric value displayed in the setting value displaying area by the fractional minimum unit by pressing down up/down keys displayed near the setting value display area.

The ninth invention is the image forming apparatus of any one of the first to third invention, wherein the setting of the image forming condition is the setting of a binding margin value in a binding margin copy mode.

The tenth invention is the image forming apparatus of any one of the first to third invention, wherein the image forming condition is an image shift width when using a tab copy function.

The eleventh invention is an image forming apparatus comprising an operating unit including a displaying unit that can display a setting input screen setting an image forming condition, an input unit that includes a numeric keypad inputting numeric information, and an input display controlling unit that displays information input from the input unit on the displaying unit,

in a setting input mode that sets the image forming condition with a numeric value in a unit system using a fractional number display, if a fractional number is a mixed fraction, the input display controlling unit displaying the numeric information input from the numeric keypad as an integer portion, a numerator portion, and a denominator portion in a setting value display area of the setting input screen.

The twelfth invention is the image forming apparatus of the eleventh invention, wherein the input display controlling unit determines whether the numeric information input from the numeric keypad corresponds to the integer portion, the numerator portion, or the denominator portion and determines the display position of the numeric information.

The thirteenth invention is the image forming apparatus of the twelfth invention, wherein the determination is performed based on a setting value input range that is preliminarily set for each of the image forming conditions, information about a minimum unit of the fractional number display, the numeric information input from the numeric keypad, and information of the number of times of the input operation.

The fourteenth invention is the image forming apparatus of the thirteenth invention, wherein based on the determination result, the input display controlling unit determines the numeric value of the numeric information input from the numeric keypad as a numeric value of the integer portion and displays a cursor at a display position of a fractional number along with a fraction symbol.

The fifteenth invention is the image forming apparatus of any one of the eleventh to fourteenth invention, wherein if an unavailable numeric value is input from the numeric keypad, the input display controlling unit invalidates the input.

The sixteenth invention is the image forming apparatus of any one of the eleventh to fourteenth invention, wherein the unit system is an inch system and wherein the minimum unit of the fractional number display is ⅛ inch.

The seventeenth invention is the image forming apparatus of any one of the eleventh to fourteenth invention, wherein when the setting input mode is selected, the input display controlling unit displays a default value in the setting value display area of the setting input screen.

The eighteenth invention is the image forming apparatus of the seventeenth invention, wherein the input display controlling unit increases/decreases the numeric value displayed on the setting input screen by the fractional minimum unit by pressing down up/down keys displayed near the setting value display area.

The nineteenth invention is the image forming apparatus of any one of the eleventh to fourteenth invention, wherein the setting of the image forming condition is the setting of an inch system sheet size.

The twentieth invention is a setting input displaying method of an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the method comprising a step of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit system using a fractional number, based on a setting value input range that is preliminarily set for each of the image forming conditions, information about a minimum unit of the fractional number display, the numeric information input from the numeric keypad, and information of the number of times of the input operation.

The twenty-first invention is the setting input displaying method of an image forming apparatus of the twentieth invention, wherein if the numeric value of the integer portion can be determined from the numeric information input from the numeric keypad, the numeric value of the numeric information is determined as the integer portion and a cursor is displayed at a display position of a fractional number along with a fraction symbol.

The twenty-second invention is the setting input displaying method of an image forming apparatus of the twentieth or twenty-first invention, wherein the unit system is an inch system and wherein the minimum unit of the fractional number display is ⅛ inch.

The twenty-third invention is the setting input displaying method of an image forming apparatus of the twentieth or twenty-first invention, wherein when the setting input mode is selected, a default value is displayed in the setting value display area of the setting input screen.

The twenty-fourth invention is the setting input displaying method of an image forming apparatus of the twentieth or twenty-first invention, wherein up/down keys are displayed near the setting value display area and wherein a value of the fractional number displayed on the setting input screen is increased/decreased by the minimum unit by pressing down the up/down keys.

The twenty-fifth invention is the setting input displaying method of an image forming apparatus of the twentieth or twenty-first invention, wherein the setting of the image forming condition is the setting of an inch system sheet size in the case of using a copy function.

The twenty-sixth invention is a computer program allowing a computer to function as an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the computer program allowing a computer to execute a process of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit, system using a fractional number, based on a setting value input range that is preliminarily set for each of the image forming conditions, information about a minimum unit of the fractional number display, the numeric information input from the numeric keypad, and information of the number of times of the input operation.

The twenty-seventh invention is a recording medium allowing a computer to function as an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the recording medium providing a computer readable program allowing a computer to execute a process of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit system using a fractional number, based on a setting value input range that is preliminarily set for each of the image forming conditions, information about a minimum unit of the fractional number display, the numeric information input from the numeric keypad, and information of the number of times of the input operation.

### BRIEF DESCRIPTION OF THE DRAWINGS

FIG. 1 is a block diagram of a digital composite machine acting as an image forming apparatus to which the present invention is applied;

FIG. 2 depicts a displaying unit and an input unit of an operating unit of the digital composite machine;

FIG. 3 depicts a screen display example of menu items when a special function is selected in a copy mode of the digital composite machine;

FIG. 4 depicts a screen display example when setting a size of binding margin copy in the special function according to an embodiment of the present invention;

FIG. 5 depicts a screen display example when setting a condition of tab copy in the special function according to the embodiment of the present invention;

FIG. 6 depicts a screen display example when setting a size of the tab copy in the special function according to the embodiment of the present invention;

FIG. 7 depicts a screen display example of menu items when user setting is selected in the digital composite machine shown in FIG. 1;

FIG. 8 depicts a screen display example when paper feed tray setting is selected in the user setting in the digital composite machine shown in FIG. 1;

FIG. 9 depicts a screen display example when “manual” is selected in the paper feed tray setting in the digital composite machine shown in FIG. 1;

FIG. 10 depicts a screen display example when type/size setting is performed in the case of “manual” according to the embodiment of the present invention;

FIG. 11 depicts a size setting screen display example when an irregularly sized inch system sheet is used in the case of “manual” according to the embodiment of the present invention;

FIG. 12 depicts sizes from “2½” inch to “17” inch of inch system sheets;

FIGS. 13A to 13H depict input display examples when setting and inputting numeric values represented as mixed fractions according to the embodiment of the present invention;

FIGS. 14A to 14F depict input display examples when setting and inputting numeric values represented as mixed fractions according to the embodiment of the present invention;

FIG. 15 is an explanatory flow diagram of input display for inch-system setting values represented as mixed fractions according to the embodiment of the present invention;

FIG. 16 depicts continuation from FIG. 15.

### PREFERRED EMBODIMENTS OF THE INVENTION

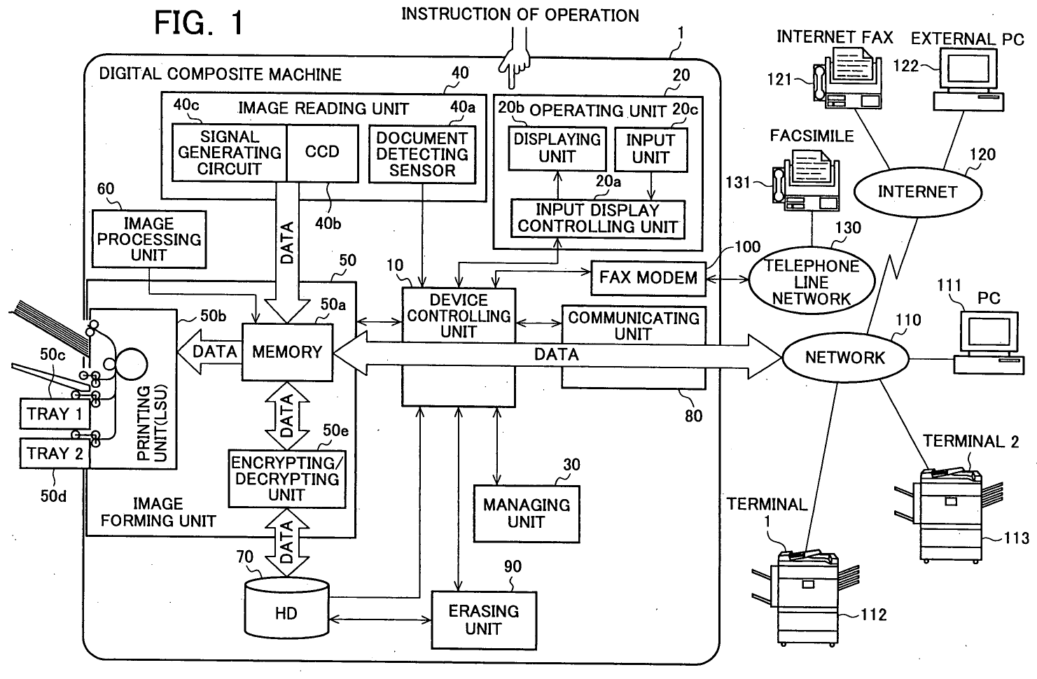

FIG. 1 is an explanatory block configuration diagram of an example when the present invention is implemented in a digital composite machine. A digital composite machine 1 includes various functions such as a copy machine, a facsimile apparatus, a network scanner apparatus, a printer apparatus, and a mail transmission apparatus and is connected to a network along with other printing apparatus, a host apparatus such as a personal computer, a server, etc. For example, the digital composite machine 1 is connected through a network 110 to a PC 111, a terminal 112, a terminal 113, etc. The digital composite machine 1 is also connected through the network 110 and the internet 120 to an internet FAX 121, an external PC 122 and further connected through a telephone line network 130 to a facsimile 131.

In FIG. 1, 10 is a device controlling unit that controls overall operation of a device; 20 is an operating unit to which the present invention is applied; and the operating unit 20 includes a displaying unit 20b that integrates a touch panel for inputting various pieces of information through user operation with a liquid crystal panel displaying information necessary for the operation and various other pieces of information, an input unit 20c including a numeric keypad for inputting numeric information, and an input display controlling unit 20a that displays information input from the input unit 20c on the displaying unit 20b.

30 is a managing unit including a memory that stores management information (various pieces of control information) for managing processes performed by the digital composite machine; 40 is an image reading unit; and the image reading unit 40 includes a document detecting sensor 40a detecting presence of a document, a CCD 40b for capturing a document image as image data, a signal generating circuit 40c that generates a signal for outputting the image data captured by the CCD 40b to an image forming unit 50, etc. 50 is the image forming unit and includes a printing unit (LSU) 50b that stores the image data read by the image reading unit 40 into a memory 50a to form and record an image from the image data stored in the memory 50a onto a recording sheet, trays 50c and 50d of sheets for forming images with the printing unit 50b, an encrypting/decrypting unit 50e that encrypts the image data stored in the memory 50a to store in the HD70 and decrypts the encrypted image data stored in the HD70, etc. 60 is an image processing unit that performs an image process for the image data stored in the memory 50a of the image forming unit 50; 70 is an HD (hard disk) that stores the image data and other information; 80 is a communicating unit for transmitting the image data generated by the image reading unit 40 through the network 110 to the personal computer 11 and receiving image data transmitted from the personal computer 111 through the network 110. 90 is an erasing unit that erases the image data, etc., stored in the HD 70, and 100 is a FAX modem for connecting to the facsimile 131 through the telephone line network 130.

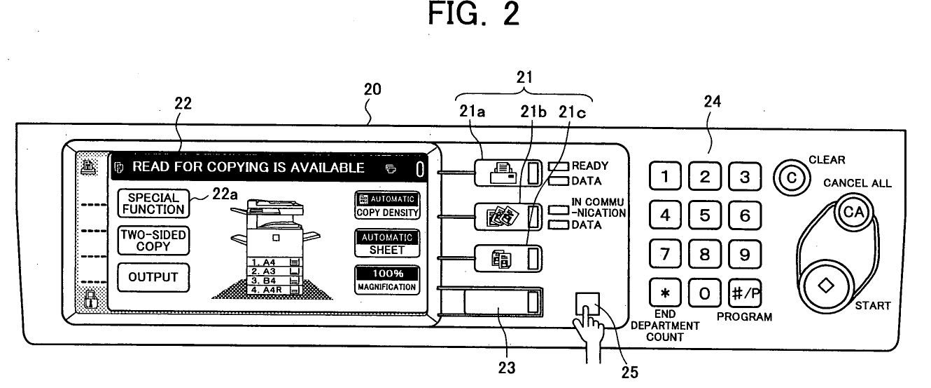

FIG. 2 depicts an example of the operating unit 20 to which the present invention is applied. In FIG. 2, 21 is function selecting keys for selecting a function utilized among a plurality of functions, and functions of a printer 21a, a fax/image transmission 21b, and copy 21c are shown in the example of FIG. 2. 22 is a touch panel for inputting and displaying selection items and various pieces of information of each function. 23 is a job status key used when displaying a job status of each function; 24 is a numeric keypad used when numerical values are input for various settings; and 25 is a user setting key used when a user performs various settings; and the user setting key 25 is used in the case of irregular sheet sizes and manual feed copying.

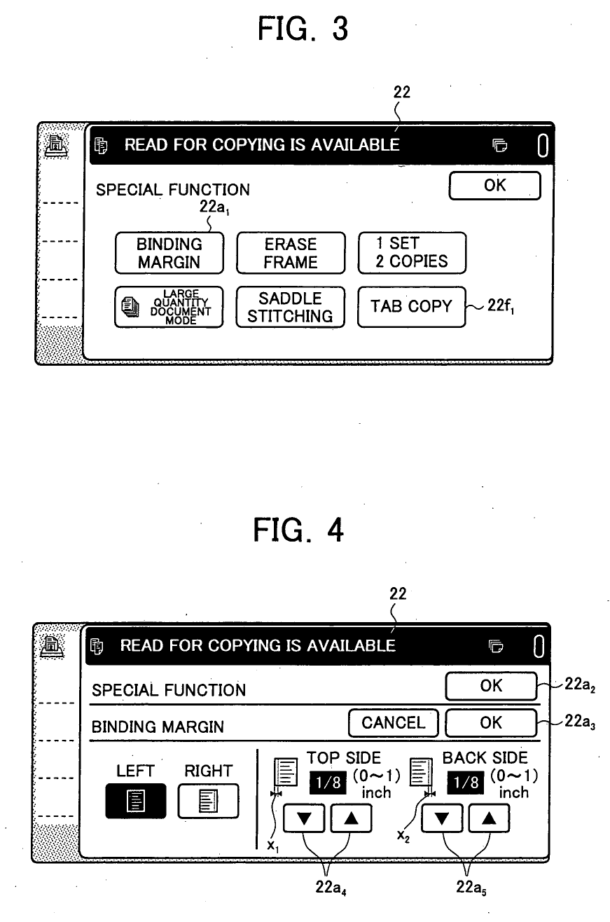

An embodiment of the present invention will be described using an example of inputting a setting value of an image forming condition of the digital composite machine. First, description will be made of “binding margin copy” having a setting value input range that is not in the form of mixed fractions. The display screen of the touch panel 22 in the operating unit 20 shown in FIG. 2 represents a menu screen when a copy mode is selected; if a “special function” 22a shown on this screen is selected, a screen of FIG. 3 appears; if a “binding margin” 22a₁ is selected from the “special function” items, a screen of FIG. 4 appears; and a “binding margin” (x₁, x₂) is set for the “binding margin copy” on this screen. FIG. 4 is an example of two-sided copying and shows that both the left and right “binding margins” are in a range of zero to one inch.

For example, to “⅛” inch as the setting value of the “binding margin” 22a₁, when “1” is input from the numeric keypad 24 (FIG. 2), “/” is automatically displayed as a fraction symbol to the right of “1”, i.e., “1/” is displayed, and a user can understand that the display is in a denominator input waiting state. If “8” is subsequently input, the display becomes “⅛”. Since a cursor is moved to a setting input position for the back side if an OK key 22a₃ is pushed, the same input operation is performed for the setting of the back side, and if the setting values are correctly input, an OK key 22a₂ for the “special function” is pushed to complete the setting of the “binding margin”.

If the setting value is one inch, “1” is input from the numeric keypad 24 and the OK key 22a₂ is pushed to complete the setting. By using up/down keys 22a₄ and 22a₅, the value can be increased or decreased by “⅛” inch. Therefore, if a default value is set to “⅛” inch, the setting of “ 2/8” inch can be achieved with a single touch of the up/down keys. In such a case, the number of times of operation is reduced as compared to the input from the numeric keypad. However, for example, if setting such as “⅝” inch is performed with the up/down keys, the key operation must normally be performed for four times. On the other hand, this can be performed by performing the key operation twice in the case of input from the numeric keypad.

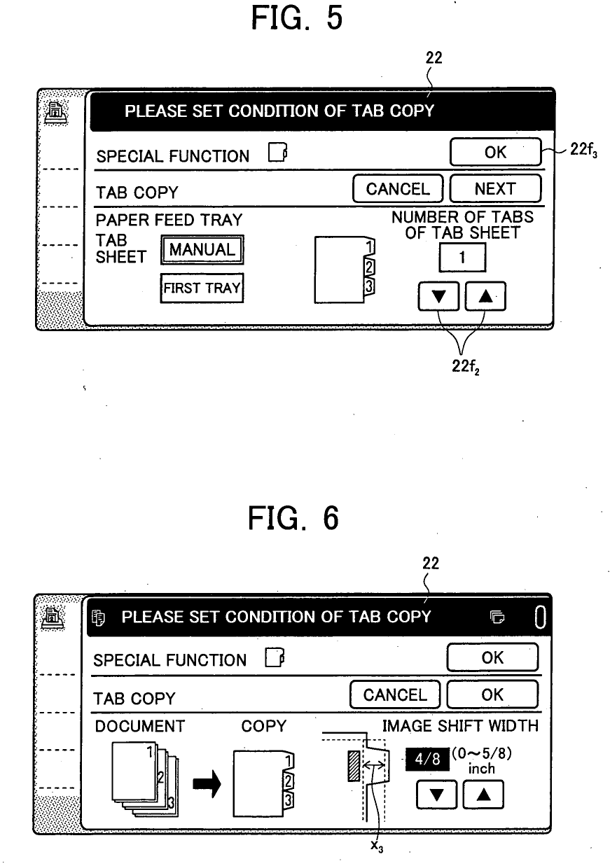

FIGS. 5 and 6 depict an example in the case of tab copy. In the tab copy, a tab sheet is set in the paper feed tray to print characters such as indexes on specified tabs of the tab sheet, and an image shift width is set in inches in this case.

To perform the tab copy, “tab copy” 22f₁ is selected on the screen of FIG. 3; the number of tabs is input with the up/down keys 22f₂ or the numeric keypad 24 on the screen of FIG. 5; and the screen of FIG. 6 is displayed by pressing down an “OK key” 22f₃. The shown example indicates that the image shift width X₃ of the tab copy is 0 inch to ⅝ inch. A method of inputting fractional number is the same as the case of setting the “binding margin” shown in FIG. 4. However, since “0 to 5” and “8” are numeric values that can input as a fractional number in the case of this example, numeric values “6, 7, and 9” are made unable to be input, and if input of these numeric values is attempted, a user is notified of an input error by generating beep sound, for example.

Description will be made of an example in the case of performing copy by manually feeding an irregularly sized inch system sheet. The setting of the sheet size must always be performed in the case of an irregularly sized sheet and manual paper feed since a document size and a sheet size are determined when copying is performed with automatic magnification, for example.

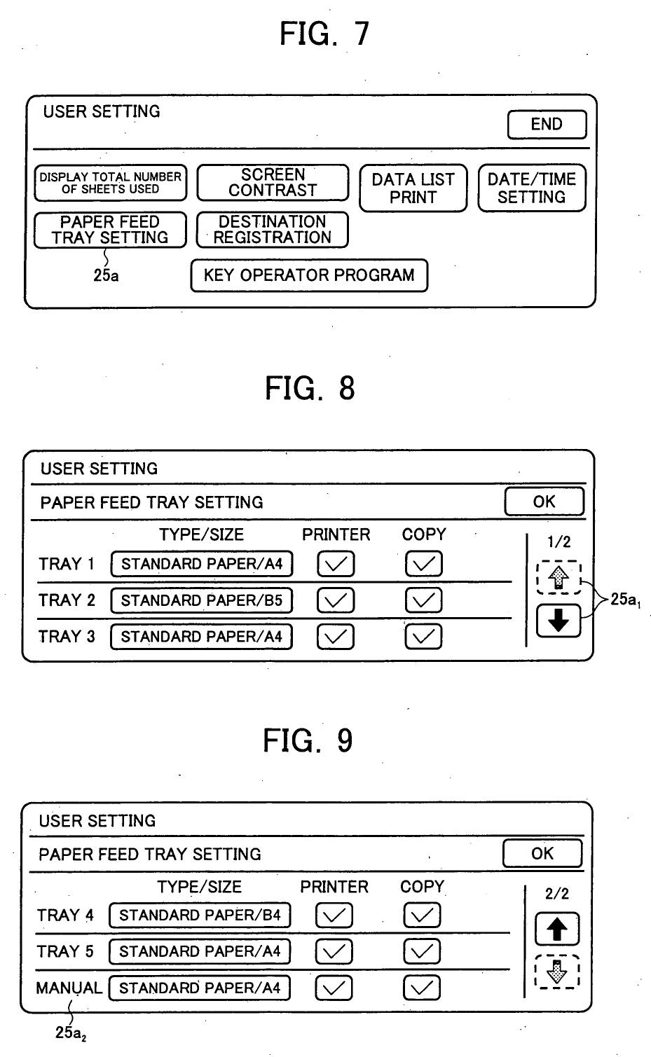

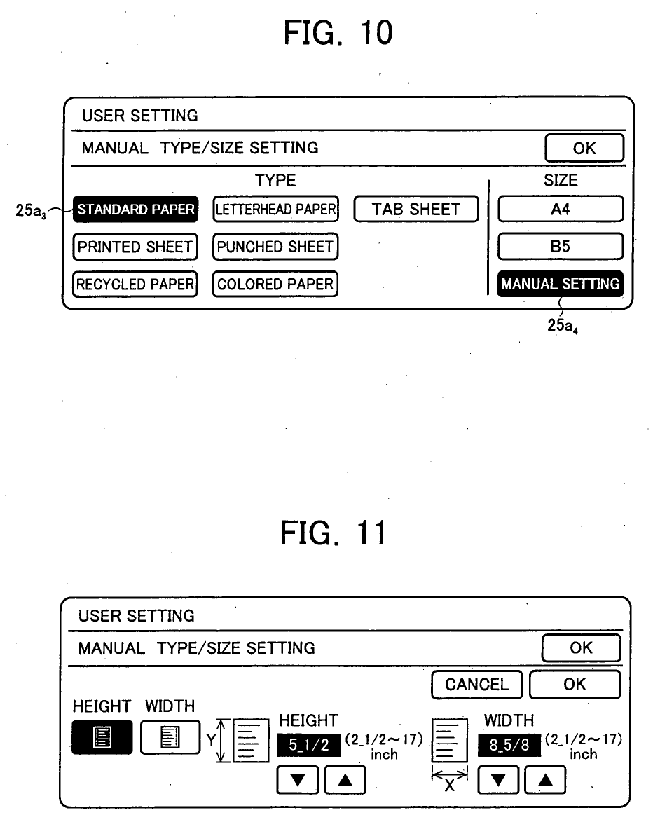

When setting a size of an inch system according to the embodiment, the user setting key 25 disposed on the input unit 20 shown in FIG. 2 is pressed down to display a sheet size setting screen shown in FIG. 7; “paper feed tray setting” 25a is selected on the screen of FIG. 7 to display a paper feed tray setting screen of FIG. 8; up/down keys 25a₁ are used to display the next screen shown FIG. 9 and select “manual” 25a₂; a paper type, for example, standard paper 25a₃ is selected on the screen of FIG. 10; and by touching “manual setting” 25a₄, a size setting screen of FIG. 11 is displayed. The display example of FIG. 11 indicates that the ranges of the sheet size are from “2½” inch to “17” inch in both height Y and width X. In the case of a sheet size in the inch system, a numeric value is represented by an integer portion and a fractional portion, and a minimum unit is “⅛” inch as is the case above.

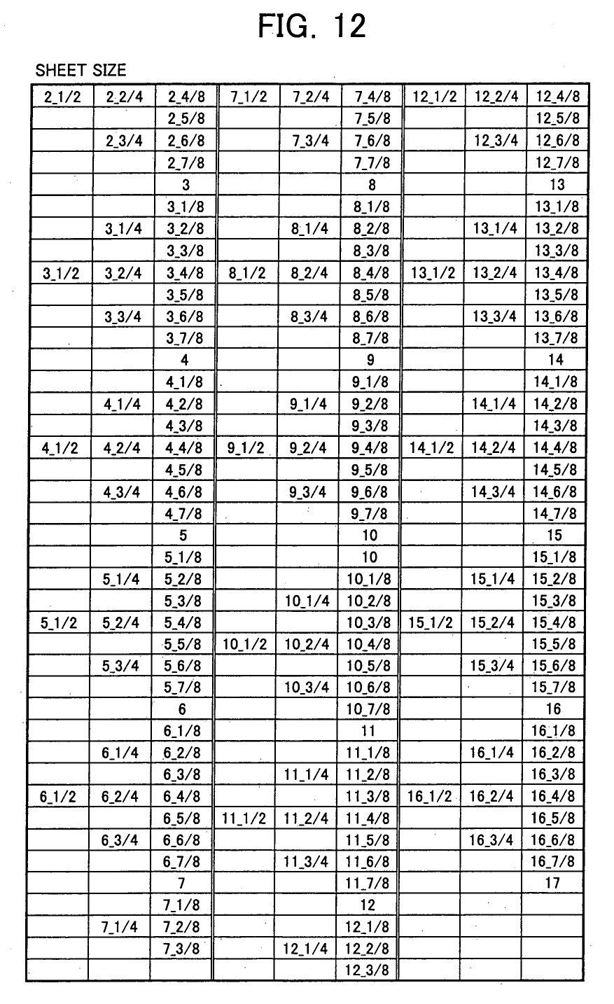

FIG. 12 is a table of numeric values that can be input in the integer portion and the fractional portion and display examples when the range of the sheet size is “2½” inch to “17” inch. As seen in the table, if a fractional number can be reduced, a value is represented by a reduced fractional number.

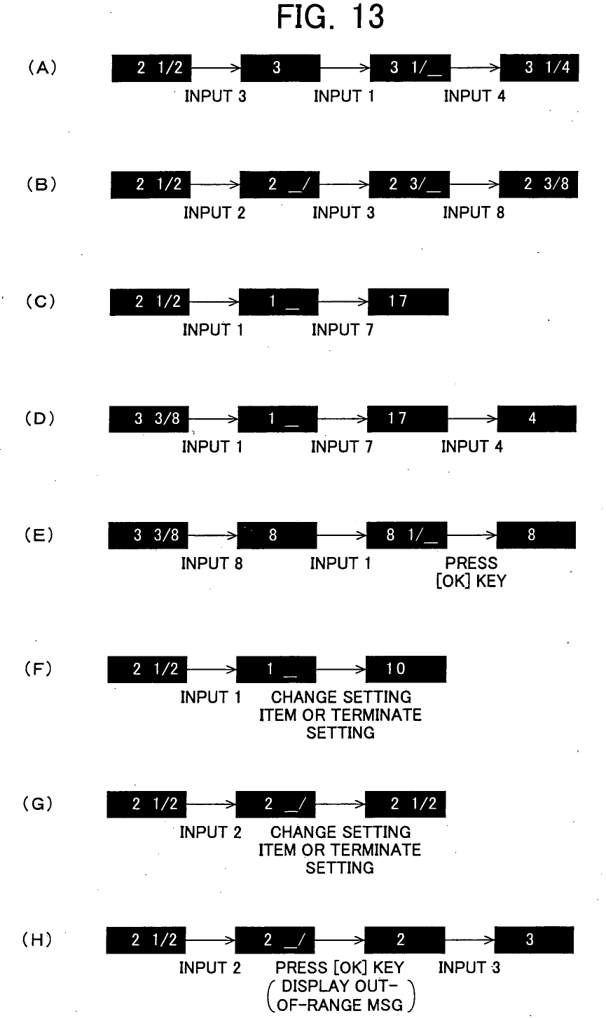

FIG. 13 shows specific input display examples when a default value is “2½” and an input range of the setting value is from “2½” inch to “17” inch.

In an example of FIG. 13A, when a numeric value greater than “3” is input first, “3” input from the numeric keypad is directly displayed, and when “1” is input, “3” and “1” are determined and displayed as numeric characters of the integer portion and the fractional portion, respectively, and “/” and a cursor are also displayed. That is, when a numeric value greater than “3” is input first, the cursor is not displayed and “3” is directly displayed since the size setting may not have the fractional portion. If the next numeric value is input without pressing the “OK” key, “3” and “1” are determined as the integer portion and the fractional portion since it can be determined that the numeric value has the fractional portion, and the cursor is displayed at the position of the denominator to indicate that the display is in a denominator input waiting state. The cursor is not displayed when the first values is greater than “3” because if the cursor is displayed when setting a size of one-digit integer portion without the fractional portion, it looks like an input waiting state and the user may be bewildered.

FIG. 13B shows an example when “2” is input first, and since a setting range cannot be defined unless the fractional portion is input, “2” is determined as a numeric value of the integer portion, and the cursor and “/” are also displayed to indicated that the display is in a input waiting state for a numerator portion. If “3” is then input, “3” is determined as a numerator, and the cursor is moved to the position of denominator to wait for input of the denominator.

If “1” is input first, the numeric value is in the ten's place of the integer portion and therefore, as shown in FIG. 13C, the cursor is displayed in the one's place of the integer portion.

In an example shown in FIG. 13D, the input is performed again from the integer portion if the numeric keypad is pressed down when the largest numeric value (“17”) of the setting range has been input.

In an example shown in FIG. 13E, if the “OK” key is pressed down in the denominator input waiting state after inputting the numerator, i.e., if the input is terminated without completing the input of the fractional portion, only the numeric value of the integer portion is valid, and the input numeric value of the numerator portion becomes invalid to start the input again from the numerator portion.

In an example shown in FIG. 13F, if the “OK” key is pressed down after inputting “1”, i.e., if the input is terminated in the state of waiting input of the one's place of the integer portion (if the setting item is changed or the setting is terminated), “0” is input in the one's place that has no input value to define the integer portion as “10”.

In an example shown in FIG. 13G, if the “OK” key is pressed down after inputting “2”, which is smaller than the minimum value, (if the setting item is changed or the setting is terminated), a rounding process is performed to input the minimum value of the input range, which is “2½”.

In an example shown in FIG. 13H, if the “OK” key is pressed down, an error message (out-of-range MSG) is displayed without the rounding process to start the input again (for example, 3 is input).

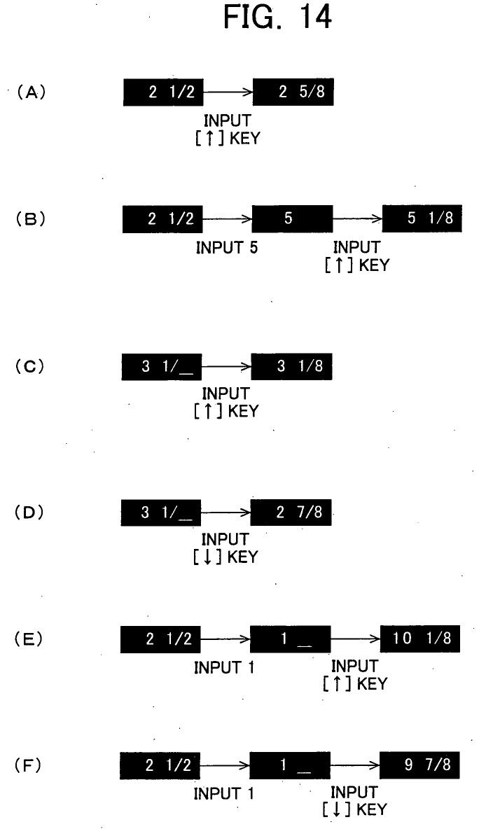

FIGS. 14A to 14F depict input examples when the numeric keypad input is combined with “↑” and “↓” key input.

In an example shown in FIG. 14A, if the default value is also “2½”, when the “↑” key is pressed down for the first time, the minimum unit “⅛” is added and the value becomes “2⅝”.

In an example shown in FIG. 14B, if “5” is input from the numeric keypad and the “↑” key is pressed down, “⅛” is added and the value becomes “5⅛”.

In an example shown in FIG. 14C, if the “↑” key is pressed down in the denominator input waiting state, it is considered that only “3” in the integer portion is determined, and “⅛” is added by pressing down the “↑”.

In an example shown in FIG. 14D, if the “↓” key is pressed down also in the denominator input waiting state, “⅛” is subtracted from “3” in the integer portion and the value becomes “2⅞”.

In an example shown in FIG. 14E, if “1” is input first, this is considered as a numeric value of the ten's place and the one's place is considered to be “0” while in the input waiting state for the one's place, and if the “↑” key is pressed down in this state, “⅛” is added to “10” and the value becomes “10⅛”.

In an example shown in FIG. 14F, if the “↓” key is pressed down after “1” is input, “⅛” is subtracted from “10” and the value becomes “9⅞”.

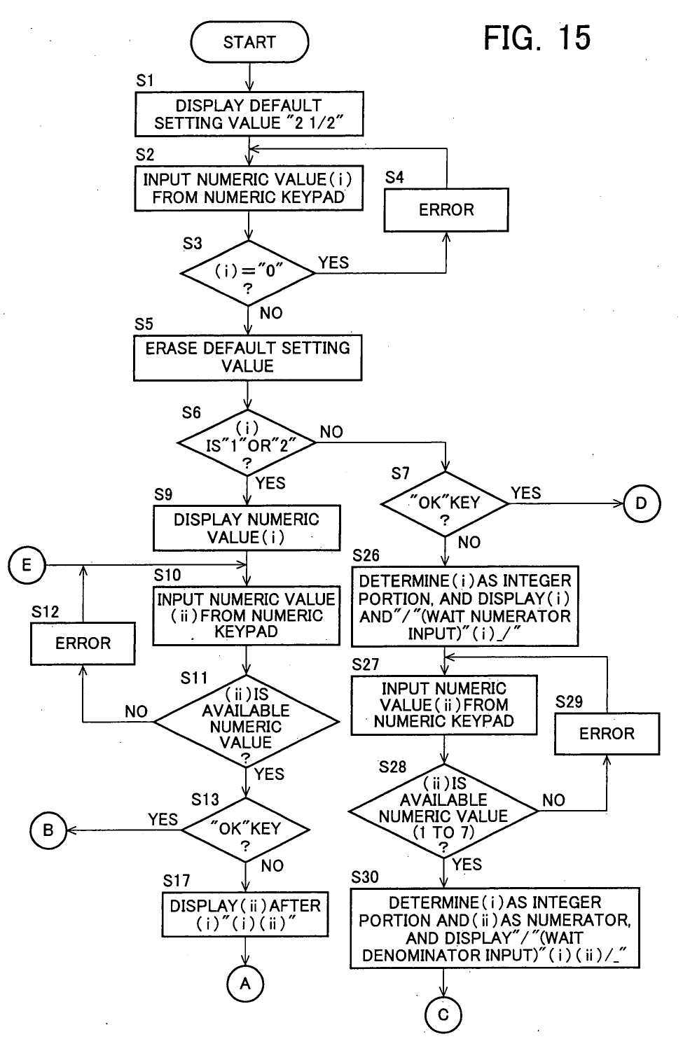

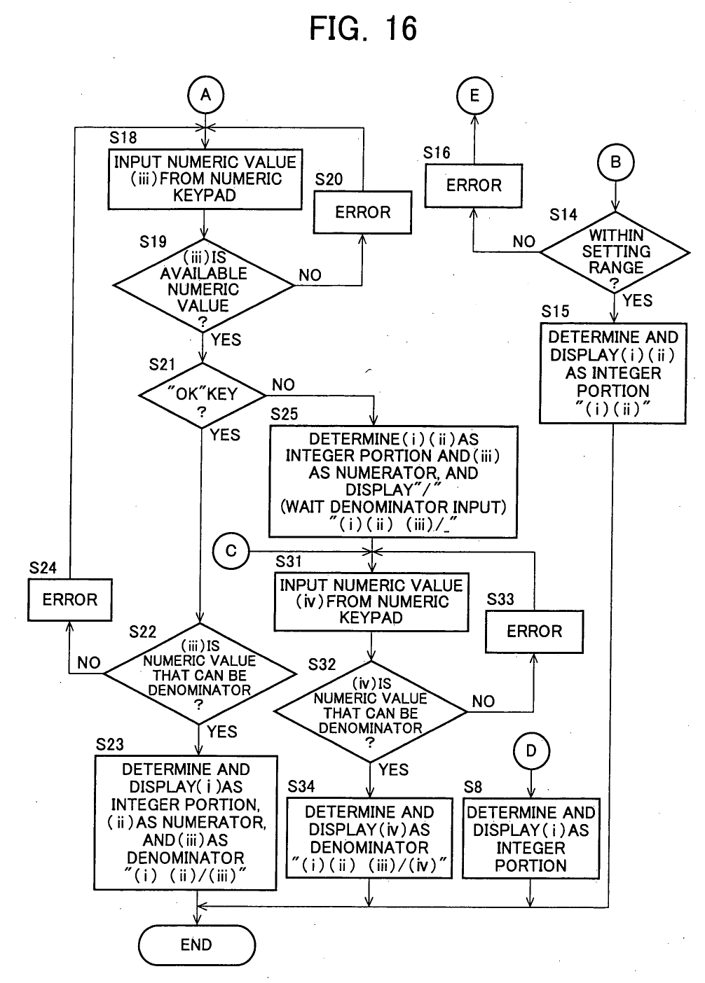

The input of a setting value of an inch system sheet size represented by a mixed fraction will be described with reference to flowcharts of FIGS. 15 and 16. It is assumed that the input range of the setting value is preliminarily set to “2½” inch to “17” inch. In the following description, symbols (i) to (iv) may indicate not only numeric values of the numeric information input from the numeric keypad but also the number of times of input or input operation.

When a setting input mode 25 is selected by the above operation, the default value of “2½” is displayed at step S1; it is determined whether first numeric information (i) input at step S2 from the numeric keypad is “0” (step S3); if the numeric information is “0” (step S3/YES), this is defined as an error (step S4) since “0” cannot be input as a numeric value of the integer portion; if the numeric information is other than “0” (step S3/NO), the display of the default value of “2½” is erased at step S5, and the flow goes to step S6.

At step S6, it is determined whether the first input numeric information (i) is “1 or 2” or greater than “3”. If the numeric information (i) is greater than “3” (step S6/NO) and the “OK” key is subsequently pressed down (step S7/YES), (i) is determined as the integer portion since the setting value is “3 to 9” inch without the fractional portion, and the numeric information is displayed to terminate the setting input flow (step S8).

If the first numeric information (i) input from the numeric keypad is “1 or 2” (step S6/YES), the numeric information (i) is displayed (step S9), and it is determined whether the next input numeric information (ii) (step S10) is an available numeric value (step S11). Since the first input numeric value is “1 or 2”, available values are “0 to 7”, and if “8” or “9” is input (step S11/NO), the value is defined as an error (step S12). If the input numeric information (ii) is an available numeric value (step S11/YES) and the “OK” key is subsequently pressed down (step S13/YES), it is determined whether a numeric value represented only by the two-digit integer portion consisting of the input numeric values (i) and (ii) is within the input range of the setting value, i.e., within 17 inch (step S14), and if the value is within the input range (step S14/YES), the numeric values of (i) and (ii) are determined as the integer portion (step S15) and the setting value input flow is terminated. If the input numeric value (ii) is out of the input range (step S14/NO), the value is defined as an error (step S16), and the flow foes back to step S10.

If the “OK” key is not pressed down at step S13 (step S13/NO), the input numeric value (ii) is directly displayed after the first input numeric value (i) (step S17). When third numeric input (iii) is performed through the numeric keypad (step S18), it is determined whether the input is an available numeric value (step S19), and since the fractional number can be ⅛ to ⅞, if “0” or “9” is input (step S19/NO), the input is defined as an error (Step S20) In the case of other numeric values (step S19/YES), if the “OK” key is pressed down (step S21/YES) and if the numeric value can be a denominator, i.e., if the numeric value is “2”, “4”, or “8” (step S22/YES), (i), (ii), and (iii) are determined as the integer portion, a numerator, and a denominator, respectively, at step S23, and the integer portion and the fractional portion are displayed to terminate the setting input flow. If the input numeric value (iii) is other than “2”, “4”, and “8” (step S22/NO), the value is defined as an error (step S24) and the flow goes back to step S18 to start the input again.

If the “OK” key is not pressed down at step S21 (step S21/NO), the flow goes to step S25 to determine (i) and (ii) as the integer portion and (iii) as the fractional portion, and “/” is also displayed and the cursor is located at a position of a denominator to enter the denominator input waiting state.

On the other hand, if the “OK” key is not pressed down at step S7 (step S7/NO), the flow goes to step S26 to determine the input numeric value (i) as the integer portion, and (i) and “/” are displayed and the cursor is located at a position of a numerator to enter the numerator input waiting state. When the second number (ii) is input from the numeric keypad at step S27 (step S27), if the number is not the available numeric value (step S28/NO), the input is defined as an error (step S29). If the number is the available numeric value, for example, a numeric value from “1 to 7” that can be a numerator (step S28/YES), the flow goes to step S30 to determine the numeric value (i) as the integer portion and the numeric value (ii) as the numerator; “/” is displayed and the cursor is moved at a position of a denominator to enter the denominator input waiting state; and the subsequent flow is in common with the above flow after step S25.

When a numeric value is input from the numeric keypad while in the denominator input waiting state (step S31), if the numeric value cannot be a denominator (step S32/NO), the value is defined as an error (step S33), and if the numeric value can be a denominator, i.e., “2”, “4”, or “8” (step S32/YES), the flow goes to step S34 to determine the numeric value (iv) as the denominator and the setting input flow is terminated.

Although a space or under bar is added such that the integer portion can be discriminated from the fractional portion when a mixed fraction is displayed, the description thereof has been omitted in the above description of the embodiment.

Although the above flow does not show the case of a fractional number the can be reduced, if a fractional number can be reduced after inputting a denominator, a flow may be inserted before the “end” to determine and display the number in the reduced form.

Since the above technical means is employed in the present invention, a setting value associated with a fractional number can easily be input from the existing numeric keypad with a fewer number of times of operation.

1. An image forming apparatus comprising an operating unit including a displaying unit that can display a setting input screen setting an image forming condition, an input unit that includes a numeric keypad inputting numeric information, and an input display controlling unit that displays information input from the input unit on the displaying unit,
in a setting input mode that sets the image forming condition with a numeric value in a unit system using a fractional number display, the input display controlling unit displaying the numeric information input from the numeric keypad as a fractional number in a setting value display area of the setting input screen.

2. The image forming apparatus as defined in claim 1, wherein when numeric information corresponding to a numerator of a fractional number is input from the numeric keypad, the input display controlling unit displays the numeric information as a numeric value for a numerator along with a fraction symbol.

3. The image forming apparatus as defined in claim 2, wherein in the case of a denominator input waiting state that displays a numeric value for a numerator and a fraction symbol, the input display controlling unit displays a cursor at a position of a denominator.

4. The image forming apparatus as defined in any one of claims 1 to 3, wherein the input display controlling unit determines whether the numeric information input from the numeric keypad is an available numeric value and invalidates the input of the numeric information in the case of an unavailable numeric value.

5. The image forming apparatus as defined in claim 4, wherein the determination is performed based on a setting value input range that is preliminarily set for each of the image forming conditions and information about a denominator that specifies a fractional minimum unit in the unit system and about a denominator when a fractional number can be reduced.

6. The image forming apparatus as defined in any one of claims 1 to 3, wherein the unit system is an inch system and wherein the fractional minimum unit is ⅛ inch.

7. The image forming apparatus as defined in any one of claims 1 to 3, wherein when the setting mode is selected, the input display controlling unit displays a default value in the setting value display area of the setting input screen.

8. The image forming apparatus as defined in claim 7, wherein the input display controlling unit increases/decreases the numeric value displayed in the setting value displaying area by the fractional minimum unit by pressing down up/down keys displayed near the setting value display area.

9. The image forming apparatus as defined in any one of claims 1 to 3, wherein the setting of the image forming condition is the setting of a binding margin value in a binding margin copy mode.

10. The image forming apparatus as defined in any one of claims 1 to 3, wherein the image forming condition is an image shift width when using a tab copy function.

11. An image forming apparatus comprising an operating unit including a displaying unit that can display a setting input screen setting an image forming condition, an input unit that includes a numeric keypad inputting numeric information, and an input display controlling unit that displays information input from the input unit on the displaying unit,
in a setting input mode that sets the image forming condition with a numeric value in a unit system using a fractional number display, if a fractional number is a mixed fraction, the input display controlling unit displaying the numeric information input from the numeric keypad as an integer portion, a numerator portion, and a denominator portion in a setting value display area of the setting input screen.

12. The image forming apparatus as defined in claim 11, wherein the input display controlling unit determines whether the numeric information input from the numeric keypad corresponds to the integer portion, the numerator portion, or the denominator portion and determines the display position of the numeric information.

13. The image forming apparatus as defined in claim 12, wherein the determination is performed based on a setting value input range that is preliminarily set for each of the image forming conditions, information about a minimum unit of the fractional number display, the numeric information input from the numeric keypad, and information of the number of times of the input operation.

14. The image forming apparatus as defined in claim 13, wherein based on the determination result, the input display controlling unit determines the numeric value of the numeric information input from the numeric keypad as a numeric value of the integer portion and displays a cursor at a display position of a fractional number along with a fraction symbol.

15. The image forming apparatus as defined in any one of claims 11 to 14, wherein if an unavailable numeric value is input from the numeric keypad, the input display controlling unit invalidates the input.

16. The image forming apparatus as defined in any one of claims 11 to 14, wherein the unit system is an inch system and wherein the minimum unit of the fractional number display is ⅛ inch.

17. The image forming apparatus as defined in any one of claims 11 to 14, wherein when the setting input mode is selected, the input display controlling unit displays a default value in the setting value display area of the setting input screen.

18. The image forming apparatus as defined in claim 17, wherein the input display controlling unit increases/decreases the numeric value displayed on the setting input screen by the fractional minimum unit by pressing down up/down keys displayed near the setting value display area.

19. The image forming apparatus as defined in any one of claims 11 to 14, wherein the setting of the image forming condition is the setting of an inch system sheet size.

20. A setting input displaying method of an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the method comprising a step of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit system using a fractional number, based on a setting value input range that is preliminarily set for each of the image forming conditions, information about a minimum unit of the fractional number display, the numeric information input from the numeric keypad, and information of the number of times of the input operation.

21. The setting input displaying method of an image forming apparatus as defined in claim 20, wherein if the numeric value of the integer portion can be determined from the numeric information input from the numeric keypad, the numeric value of the numeric information is determined as the integer portion and a cursor is displayed at a display position of a fractional number along with a fraction symbol.

22. The setting input displaying method of an image forming apparatus as defined in claim 20 or 21, wherein the unit system is an inch system and wherein the minimum unit of the fractional number display is ⅛ inch.

23. The setting input displaying method of an image forming apparatus as defined in claim 20 or 21, wherein when the setting input mode is selected, a default value is displayed in the setting value display area of the setting input screen.

24. The setting input displaying method of an image forming apparatus as defined in claim 20 or 21, wherein up/down keys are displayed near the setting value display area and wherein a value of the fractional number displayed on the setting input screen is increased/decreased by the minimum unit by pressing down the up/down keys.

25. The setting input displaying method of an image forming apparatus as defined in claim 20 or 21, wherein the setting of the image forming condition is the setting of an inch system sheet size in the case of using a copy function.

26. A computer program allowing a computer to function as an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the computer program allowing a computer to execute a process of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit system using a fractional number, based on a setting value input range that is preliminarily set for each of the image forming conditions, information about a minimum unit of the fractional number display, the numeric information input from the numeric keypad, and information of the number of times of the input operation.

27. A recording medium allowing a computer to function as an image forming apparatus comprising an operating unit including a displaying unit that can display a setting input screen setting an image forming condition, an input unit that includes a numeric keypad inputting numeric information, and an input display controlling unit that displays information input from the input unit on the displaying unit, the recording medium providing a computer readable program allowing a computer to execute a process of determining whether the numeric information input from the numeric keypad corresponds to an integer portion of a fractional number, a numerator portion, or a denominator portion of a fractional number to display the numeric information as a fractional number in a setting value display area of the setting input screen, in a setting input mode that sets the image forming condition with a numeric value in a unit system using a fractional number, based on a setting value input range that is preliminarily set for each of the image forming conditions, information about a minimum unit of the fractional number display, the numeric information input from the numeric keypad, and information of the number of times of the input operation.
